(19) United States
(12) Patent Application Publication
(10) Pub. No.: US 2025/0277121 A1
(43) Pub. Date: Sep. 4, 2025

(54) CORROSION RESISTANT PAINT REMOVER EMULSION COMPOSITIONS

(71) Applicant: W. M. BARR & COMPANY, INC,, Memphis, TN (US)

(72) Inventors: Dalton BOLGEO, Memphis, TN (US); Jonathan Breon, Memphis, TN (US); Rachel Farmer, Memphis, TN (US); Timothy Teague, Memphis, TN (US)

(21) Appl. No.: 19/065,019

(22) Filed: Feb. 27, 2025

Related U.S. Application Data
(60) Provisional application No. 63/560,245, filed on Mar. 1, 2024.

(51) Int. Cl. C09D 9/00

(52) U.S. Cl. CPC C09D 9/005

(57) ABSTRACT

A paint remover composition and a method of removing paint from both porous and non-porous substrates is disclosed. The paint remover composition is an emulsion comprising from 5 weight percent to 80 weight percent benzyl alcohol; from 30 weight percent to 70 weight percent water; a terpene hydrocarbon; and an alcohol ethoxylate phosphate ester at an effective concentration to emulsify the composition and provide corrosion inhibition.

### FIELD

The present invention relates to the field of paint removers, and more particularly, to corrosion-resistant emulsion compositions that effectively and safely remove paint and coatings from both porous and non-porous substrates.

### BACKGROUND OF THE INVENTION

Paint removers, also commonly referred to as paint strippers, have been utilized for refinishing antique furniture, or woodworking's (doors, frames, moldings, etc.) and more recently to customize metal drinkware. Many of these items have been painted and repainted many times over. This results in items having multiple layers of paint containing different chemistry types and a different degree of difficulty from being removed. Paint removers are also used in the auto body repair industry to help with vehicle restoration. The components of paint removers may cause corrosion when the paint remover is stored in a metal container or used on a metal substrate. In general, corrosion is defined as a destructive attack on metal involving an electrochemical or chemical reaction of the metal with its environment. More specifically, an electrochemical attack on a metal surface is the wearing away and undercutting of the metal, which is accelerated after the protective coating, e.g., the oxide film is removed by the corrosive medium. It has recently been found that some basic activators typically used in paint removing compositions have resulted in increased corrosion on certain metal substrates as well as darken wood substrates.

### BRIEF SUMMARY

To provide a paint remover that can remove various types of paint from various substrates, a paint remover composition is disclosed. The paint remover composition described herein prevents corrosion of metal containers and/or metal substrates as well as prevents discoloration of porous substrates such as wood.

In one aspect, the paint remover composition for the removal of paints and coatings is an emulsion comprising (a) from 15 weight percent to 70 weight percent benzyl alcohol as a primary solvent, based on the total weight of the composition; (b) from 10 weight percent to 70 weight percent water, based on the total weight of the composition (c) a secondary solvent, and (d) an alcohol ethoxylate phosphate ester at an effective concentration to emulsify the composition and provide corrosion inhibition.

In certain aspects, the composition comprises water from 30 weight percent to 65 weight percent; preferably from 45 weight percent to 55 weight percent, based on the total weight of the composition.

In certain aspects, the composition comprises benzyl alcohol from 30 weight percent to 65 weight percent, and most preferably from 45 weight percent to 55 weight percent, based on the total weight of the composition.

In certain aspects, the benzyl alcohol and water are present in the composition at a ratio of 1.5:1 to 1:1.5, more preferably 1:1.

In certain aspects, the composition further comprises an acidic accelerator. The acidic accelerator may be phosphoric acid, formic acid, glycolic acid, or a combination thereof.

In certain aspects, the secondary solvent comprises dipentene, toluene, turpentine, mineral spirits, xylene, DMSO, and combinations thereof.

In certain aspects, the composition further comprises a thickener.

In certain aspects, the composition further comprises a propellant.

In certain aspects, the composition comprises a secondary corrosion inhibitor.

In certain aspects, the alcohol ethoxylate phosphate ester has a hydrophilic lipophilic balance from 3 to 7. In certain aspects, the alcohol ethoxylate phosphate ester comprises a monophosphate ester, a diphosphate ester, or a combination thereof. In certain aspects, wherein the alcohol ethoxylate phosphate ester has from 2-10 degrees of ethoxylation. In certain aspects, wherein the alcohol ethoxylate phosphate ester has from 3-5 degrees of ethoxylation. In certain aspects, wherein the alcohol ethoxylate phosphate ester comprises an alcohol chain that is from 16 to 22 carbons long. In certain aspects, the alcohol chain is oleyl alcohol.

In certain aspects, the composition removes at least three layers of latex-based paint after one hour. In certain aspects, the composition removes at least five layers of oil-based paint after twenty-four hours. In certain aspects, when the composition is applied to a wood substrate, it results in treated wood having an L-value of greater than −2, when compared to untreated wood.

In certain aspects, the composition has a flash point of 70° F. or greater. In certain aspects, the composition has a volatile organic compound (VOC) content of 50 weight percent or less based on the total weight of the composition.

In another aspect, a method of removed paint from a substrate is disclosed. The method comprising: (a) applying the paint remover composition as described above to a painted substrate, (b) leaving the composition on the painted substrate for a period of time, (c) removing the paint from the substrate.

In certain aspects, the method removes latex-based paint. In certain aspects, the method removes at least three layers of latex-based paint after one hour. In certain aspects, the method removes oil-based paint. In certain aspects, the method removes at least three layers of oil-based paint after twenty-four hours.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects and advantages of the present invention are better understood when the following detailed description of the invention is read with reference to the accompanying drawings, in which:

FIG. 1A graphically illustrates the ability of an exemplary composition to remove latex paint from a painted substrate.

FIG. 1B graphically illustrates the ability of a comparative composition to remove latex paint from a painted substrate.

FIG. 2A illustrates the wood-darkening properties of an exemplary composition and a comparative composition on oak.

FIG. 2B illustrates the wood-darkening properties of an exemplary composition and a comparative composition on birch.

FIG. 2C illustrates the wood-darkening properties of an exemplary composition and a comparative composition on pine.

FIG. 2D illustrates the wood-darkening properties of an exemplary composition and a comparative composition on fir.

FIG. 2E illustrates the wood-darkening properties of an exemplary composition and a comparative composition on maple.

FIG. 2F illustrates the wood-darkening properties of an exemplary composition and a comparative composition on poplar.

FIG. 2G illustrates the wood-darkening properties of an exemplary composition and a comparative composition on cedar.

FIG. 2H illustrates the wood-darkening properties of an exemplary composition and a comparative composition on white oak.

FIG. 3A illustrates the vertical cling of an exemplary composition and a comparative composition on an aluminum substrate at a 90° angle post application.

FIG. 3B illustrates the vertical cling of an exemplary composition and a comparative composition on an aluminum substrate at a 90° angle 5 minutes post application.

FIG. 3C illustrates the vertical cling of an exemplary composition and a comparative composition on an aluminum substrate at a 90° angle 15 minutes post application.

FIG. 3D illustrates the vertical cling of an exemplary composition and a comparative composition on an aluminum substrate at a 90° angle 1 hour post application.

FIG. 3E illustrates the vertical cling of an exemplary composition and a comparative composition on an aluminum substrate at a 90° angle 7 hours post application

FIG. 3F illustrates the vertical cling of an exemplary composition and a comparative composition on an aluminum substrate at a 90° angle 72 hours post application FIG. 4A illustrates the vertical cling of an exemplary composition and a

comparative composition on a painted wood substrate at a 90° angle post application.

FIG. 4B illustrates the vertical cling of an exemplary composition and a comparative composition on a painted wood substrate at a 90° angle 5 minutes post application.

FIG. 4C illustrates the vertical cling of an exemplary composition and a comparative composition on a painted wood substrate at a 90° angle 15 minutes post application.

FIG. 4D illustrates the vertical cling of an exemplary composition and a comparative composition on a painted wood substrate at a 90° angle 1 hour post application.

FIG. 4E illustrates the vertical cling of an exemplary composition and a comparative composition on a painted wood substrate at a 90° angle 7 hours post application

FIG. 4F illustrates the vertical cling of an exemplary composition and a comparative composition on a painted wood substrate at a 90° angle 72 hours post application

FIG. 5A illustrates the vertical cling of an exemplary composition and a comparative composition on an untreated wood substrate at a 90° angle post application.

FIG. 5B illustrates the vertical cling of an exemplary composition and a comparative composition on an untreated wood substrate at a 90° angle 5 minutes post application.

FIG. 5C illustrates the vertical cling of an exemplary composition and a comparative composition on an untreated wood substrate at a 90° angle 15 minutes post application.

FIG. 5D illustrates the vertical cling of an exemplary composition and a comparative composition on an untreated wood substrate at a 90° angle 1 hour post application.

FIG. 5E illustrates the vertical cling of an exemplary composition and a comparative composition on an untreated wood substrate at a 90° angle 7 hours post application FIG. 5F illustrates the vertical cling of an exemplary composition and a

comparative composition on an untreated wood substrate at a 90° angle 72 hours post application

FIG. 6A graphically illustrates the vertical cling data for both an exemplary composition and a comparative composition on a painted wood substrate.

FIG. 6B graphically illustrates the vertical cling data for both an exemplary composition and a comparative composition on an untreated wood substrate.

FIG. 6C graphically illustrates the vertical cling data for both an exemplary composition and a comparative composition on an aluminum substrate.

FIG. 7A illustrates the paint removal of an exemplary composition and a comparative composition after application to a painted wood substrate at a 70° angle after being left overnight.

FIG. 7B illustrates the paint removal of an exemplary composition and a comparative composition after application to a painted wood substrate at a 70° angle after being left overnight and then scraped with a paint scraper.

FIG. 7C illustrates the paint removal of an exemplary composition and a comparative composition after application to a painted wood substrate at a 90° angle after being left overnight.

FIG. 7D illustrates the paint removal of an exemplary composition and a comparative composition after application to a painted wood substrate at a 90° angle after being left overnight and then scraped with a paint scraper.

### DETAILED DESCRIPTION OF EMBODIMENTS OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use and practice the invention. Further, the term “or” as used in this disclosure and the appended claims is intended

to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described. The above further applies to any disclosed ratios and/or range of ratios disclosed herein as well as predetermined time ranges.

### Paint Remover Compositions

Provided herein are paint removing emulsion compositions with corrosion inhibition. The paint remover composition is configured to remove one or more layers of paint from a surface, such as metal and/or wood, both porous and non-porous. The composition provides a clean removal of the paint layers without significantly darkening the underlying wood or surface.

Paint remover compositions contain a variety of solvents to swell and lift the dried paint. These solvents are designed to solvate the various portions of the dried paint matrix, whether it originates from a latex paint or oil-based paint. Within the solvent system, traditional paint removers may have a primary amine component which could have potential interactions with the components of a wood, or wood-containing substrate. The components of wood that could present interactions with primary amine structures are tannins naturally present in wood or those tannins that have been added to give wood a specific hue or shade. Other components that could be present include metallic salts, such as copper and cadmium. Manufacturers of the wood may have introduced those as preservatives or from a processing step of the wood. As such, these metallic components may interact with some primary amine compounds to darken the wood, either through oxidation or metal to amine complexation.

The paint remover composition disclosed herein comprises from 15 weight percent to 70 weight percent benzyl alcohol, more preferably 30 weight percent to 65 weight percent benzyl alcohol, and most preferably 45 weight percent to 55 weight percent benzyl alcohol.

Additionally, the paint remover composition comprises from 10 weight percent to 70 weight percent water, more preferably 30 weight percent to 65 weight percent water, and most preferably 45 weight percent to 55 weight percent water.

A secondary solvent may be included in the paint remover composition to keep the emulsion together and the water dispersed/suspended in the oil phase of the emulsion. The paint remover composition comprises from 1 weight percent to 50 weight percent of a secondary solvent, more preferably 2 weight percent to 30 weight percent, and most preferably 3 weight percent to 15 weight percent, based on the total weight of the composition. The secondary solvent may be ethanol, propanol, butanol, methanol, dimethyl sulfoxide (DMSO), Aromatic 100 (comprised of primarily C₉-C₁₀ dialkyl and trialkylbenzenes), Aromatic 200 (comprised of primarily C₁₁-C₁₆ aromatic hydrocarbons), alkyl benzene derivatives, benzyl alcohol, 2-butoxyethanol, diethylene glycol monobutyl ether acetate, propylene carbonate, tetrahydrofuran (THF), ethyl benzene, mesitylene, durene, sec-amylbenzene, n-butylbenzene, naphthalene, methyl naphthalene, methylene chloride, mineral spirits, toluene, xylene or xylene containing mixture of isomers and ethyl benzene, N,N-dimethyl formamide (DMF), terpenes, dimethyl carbonate, diethyl carbonate, dipropyl carbonate, kerosene, turpentine, raffinates (petroleum) mineral spirits, dipentene ((+/−)-limonene), citral, geraniol, linalool, and combinations thereof.

The paint remover composition comprises an alcohol ethoxylate phosphate ester. The alcohol ethoxylate phosphate ester functions as both a corrosion inhibitor and an emulsifier in the paint remover composition. The paint remover composition comprises from 0.1 weight percent to 5 weight percent of a phosphate ester of an ethoxylated alcohol, wherein the alcohol is an unsaturated alcohol, preferably from 0.3 weight percent to 4 weight percent, and most preferably from 0.5 weight percent to 3 weight percent, based on the total weight of the composition. The alcohol ethoxylate phosphate ester may comprise an alcohol chain that is 16 to 22 carbons long. The alcohol ethoxylate phosphate ester may comprise oleyl alcohol. The alcohol ethoxylate phosphate ester may have a hydrophilic lipophilic balance between 3 and 7. The alcohol ethoxylate phosphate ester may comprise a monophosphate ester, a diphosphate ester, or a combination thereof. The alcohol ethoxylate phosphate ester should have solubility in the oil phase of the water-in-oil emulsion. This allows the alcohol ethoxylate phosphate ester, and the activity thereof, to be on the surface of the composition. The degree of ethoxylation has an effect on the water/oil solubility of the alcohol ethoxylate phosphate ester. The alcohol ethoxylate phosphate ester may have a degree of ethoxylation from 2-10, more preferably the alcohol ethoxylate phosphate ester has a degree of ethoxylation from 3-5.

Passivating corrosion inhibitors, such as the alcohol ethoxylate phosphate ester used herein, cause a large anodic shift of the corrosion potential, forcing the metallic surface into the passivation range. There are two types of passivating corrosion inhibitors: oxidizing anions, such as chromate, nitrite, and nitrate, which can passivate steel in the absence of oxygen and the nonoxidizing ions, such as phosphate, tungstate, and molybdate, which requires the presence of oxygen to passivate steel.

The paint remover composition may optionally comprise a secondary corrosion inhibitor configured to inhibit corrosion on yellow metals such as copper and brass. Secondary corrosion inhibitors include, but are not limited to: VANLUBE® 871 (2,5-dimercapto-1,3,4-thiadiazole, alkylpolycarboxylates), VANCHEM® NATD (disodium 2,5-dimercapto-1,3,4-thiadiazole), NACAP® (Sodium mercaptobenzothiazole), ELCO® 461

(Alkylmercaptothiadiazole), Irgamet 39 (N,N-bis-(2-ethylhexyl)-ar-methyl-1H-benzotriazole-1-methanamine), Irgamet TT50 (Tolytriazole sodium salt), Irgamet 42 (Ethanol, 2,2-(methyl-1H-benzotriazol-1-yl)methyliminobis), other tolutriazole derivatives, and a combination thereof.

The paint remover composition may optionally comprise from 0.5 weight percent to 30 weight percent of an acidic activator, preferably from 1 weight percent to 20 weight percent, and most preferably from 3 weight percent to 10 weight percent, based on the total weight of the composition. Activators in paint removers increase the penetration of the solvent into the paint.

The acidic activator in the paint remover composition may comprise a strong organic reducing agent such as formic acid as an activator. Other organic acids soluble in aromatic hydrocarbon solvents without oxidation, such as acetic acid and oxalic acid, are anticipated to be substituents in the composition of the present invention. The use of an acidic activator is particularly preferred for removing old, accumulated paint layers from wood or other surfaces where corrosion inhibition is unnecessary.

The paint remover composition may optionally comprise a secondary solvent or a blend of secondary solvents. The secondary solvent may be present at a concentration from 3 weight percent to 70 weight percent, preferably from 5 weight percent to 20, weight percent, and more preferably from 5 weight percent to 10 weight percent. Examples of secondary solvents include: ethanol, propanol, butanol, methanol, dimethyl sulfoxide (DMSO), toluene, xylene or xylene containing mixture of isomers and ethyl benzene, Aromatic 100 (comprised of primarily C₉-C₁₀ dialkyl and trialkylbenzenes), Aromatic 200 (comprised of primarily C₁₁-C₁₆ aromatic hydrocarbons), alkyl benzene derivatives, benzyl alcohol, 2-butoxyethanol, diethylene glycol monobutyl ether acetate, propylene carbonate, tetrahydrofuran (THF), turpentine, mineral oil (also referred to as liquid petrolatum or liquid paraffin), ethyl benzene, mesitylene, durene, sec-amylbenzene, n-butylbenzene, naphthalene, methyl naphthalene, methylene chloride, N,N-dimethyl formamide (DMF), terpenes, dimethyl carbonate, diethyl carbonate, dipropyl carbonate, kerosene, raffinates (petroleum), mineral spirits, dipentene, (+/−)-limonene, (+)-limonene, (−)-limonene, citral, geraniol, linalool, and combination(s) thereof.

The paint remover composition may further comprise an additive including, but not limited to, a surfactant (preferably a non-ionic surfactant), an ether containing compound such as diethyl glycol monobutyl ether, a dye, a fragrance, a thickener, a wax, other additive, or a combination thereof.

Non-limiting examples of a thickener include a hydroxypropyl methyl cellulose thickener such as METHOCEL™ 311 (The Dow Chemical Company) or TYLOSE® PSO 81001 (ShinEtsu Se TYLOSE® GmbH & Co. KG), and a hydroxy propylcellulose thickener such as KLUCEL™ PR (Ashland), METHOCEL™ J75MS (HPMC Dow).

The paint remover composition may have a total volatile organic compound (VOC) (as defined in 40 CFR 51.100 (s) by the Environmental Protection Agency (EPA)) content of 50 weight percent (%) or less, wherein the weight percent is based on the weight of the total composition.

The paint remover composition may have a flash point at or above room temperature of 70° F.

The paint remover composition can be combined with a propellant and combined with other ingredients to be delivered in an aerosol format. Non-limiting examples of propellants include propane, butane, pentane, carbon dioxide, nitrous oxide, nitrogen, any other inert gas, and combinations thereof.

The viscosity of the paint remover composition was measured using a Brookfield Viscometer (RVT #6 @ 20 rpm). The paint remover compositions preferably have a viscosity from 20,000 cps to 40,000 cps. The paint remover composition should have a viscosity high enough to achieve the desired vertical cling to stay in contact with the substrate for an extended period of time to remove the paint, but not so high as to not evenly coat the substrate.

### Method of Removing Paint

Also disclosed is a method of removing paint including (a) applying the paint remover composition disclosed herein to a painted substrate; (b) leaving the composition on the painted substrate for a period of time, (c) removing the composition and paint from the substrate; wherein the substrate is not discolored after step (c). As alluded to above, the disclosed paint remover compositions are suitable for chemically stripping paint of various kinds on various surfaces. The paints include, for example, automotive paints having a plurality of layers (i.e., a primer layer, a base/pigment layer, and a top-coat/clear layer) and/or wall paints. In certain aspects, the paints that will be removed have been applied to, for example, porous (wood/sheetrock/gypsum board) and/or non-porous surfaces (metal or glass substrates).

### WORKING EXAMPLES

Various corrosion inhibitors were analyzed for their inhibition of corrosion on various metal substrates (brass, copper, steel, aluminum), the data is shown in Table 1. Corrosion inhibition of steel and/or aluminum was achieved with COLARFax 3397, a water and oil soluble alcohol ethoxylate phosphate ester with 4.5 degrees of ethoxylation, and SP CRODAFOS™ O3A MBAL-LQ-(MH), an oil-soluble alcohol ethoxylate phosphate ester with 3 degrees of ethoxylation. VANLUBE® 871 also showed corrosion inhibition on steel.

TABLE 1

| | | Tested With: | | | | | |
|---|---|---|---|---|---|---|---|
| Corrosion | | Formic | Phosphoric | Inhibition of Substrate | | | |
| Inhibitor | CAS # | Acid | Acid | Copper | Brass | Steel | Aluminum |
| VANLUBE ® 871 | 12610 | yes | no | yes | yes | yes | n/a |
| | 4-53-8 | | | | | | |
| VANCHEM ® | 55906- | yes | no | yes | yes | no | n/a |
| NATD | 42-8 | | | | | | |
| NACAP ® | 2492- | yes | no | yes | yes | no | n/a |
| | 26-4 | | | | | | |
| ELCO ® 461 | N/A | yes | no | yes | yes | no | n/a |
| (Alkylmercaptothia- | | | | | | | |
| diazole) | | | | | | | |
| Irgamet 39 | 94270- | yes | yes | yes | yes | no | n/a |
| | 86-7 | | | | | | |
| BIO-SOFT ® TA-2 | 61791- | yes | yes | n/a | n/a | no | no |
| | 26-2 | | | | | | |
| Triethanolamine | 102- | yes | no | n/a | n/a | no | n/a |
| | 71-6 | | | | | | |
| PRIMINE ™ 81-R | 68955- | yes | no | n/a | n/a | no | n/a |
| Amine | 53-3 | | | | | | |
| HALOX ® 630 | 12507 | yes | no | n/a | n/a | no | n/a |
| | 8-60-6 | | | | | | |
| HALOX ® 570 | 17105 | yes | no | n/a | n/a | no | n/a |
| | 4-89-0 | | | | | | |
| Oleic Acid | 112- | yes | no | n/a | n/a | no | n/a |
| | 80-1 | | | | | | |
| Sarkosyl O | 110- | yes | no | n/a | n/a | no | n/a |
| | 25-8 | | | | | | |
| Irgacor L 190 | 80584- | yes | no | n/a | n/a | no | n/a |
| | 91-4 | | | | | | |
| COLA ®Fax 3397 | 39464- | yes | yes | n/a | n/a | yes | no |
| (Oleyl alcohol, | 69-2 | | | | | | |
| ethoxylate, | | | | | | | |
| phosphate) | | | | | | | |
| COLA ®lube 3404 | 12645- | yes | no | n/a | n/a | no | n/a |
| (alkyl phosphate | 31-7 | | | | | | |
| esters) | | | | | | | |
| sodium nitrite | 7632- | yes | no | n/a | n/a | no | n/a |
| | 00-0 | | | | | | |
| CRODAZOLINE ™ | 21652- | yes | yes | n/a | n/a | no | n/a |
| O-NV-LQ | 27-7 | | | | | | |
| Irgamet TT50 | 64665- | yes | no | yes | yes | no | no |
| | 57-2 | | | | | | |
| Irgamet 42 | 88477- | no | yes | yes | yes | no | n/a |
| | 37-6 | | | | | | |
| THIATE ® U | 109- | yes | no | no | no | no | no |
| | 46-6 | | | | | | |
| COLA ®Cor 100 | 68815- | yes | no | no | no | no | n/a |
| (short-chain | 55-4 | | | | | | |
| imidazolines) | | | | | | | |
| monoethanolamine | 141- | yes | no | n/a | n/a | n/a | no |
| | 43-5 | | | | | | |
| morpholine | 110- | yes | no | n/a | n/a | n/a | no |
| | 91-8 | | | | | | |
| LUBRIZOL ® 219 | 68457- | yes | yes | n/a | n/a | n/a | no |
| (organic phosphate- | 79-4 | | | | | | |
| zinc complex) | | | | | | | |
| DAPRAPHOS ® ASI | 4724- | yes | yes | n/a | n/a | n/a | no |
| 80 (alkyl- | 48-5 | | | | | | |
| phosphonic acid in | | | | | | | |
| water and alkyl | | | | | | | |
| glycol) | | | | | | | |
| COLA ®Cor 700 | 14852- | yes | yes | n/a | n/a | n/a | no |
| (blend of | 17-6 | | | | | | |
| alkanolamine | | | | | | | |
| borates and amine | | | | | | | |
| phosphates) | | | | | | | |
| COLA ®Teric HLA | 14960- | yes | yes | n/a | n/a | n/a | no |
| | 06-6 | | | | | | |
| COLA ®Mid OA | 93-83- | yes | no | n/a | n/a | n/a | no |
| | 4 | | | | | | |
| COLA ®Liquid DO | 40516 | no | yes | n/a | n/a | n/a | no |
| | 0-18-1 | | | | | | |
| COLA ®Carb O2C | 22731 | no | yes | n/a | n/a | n/a | no |
| | 0-69-2 | | | | | | |
| COLA ®Cor KAT | N/A | no | yes | n/a | n/a | n/a | no |
| (blend of water- | | | | | | | |
| soluble phosphate | | | | | | | |
| esters) | | | | | | | |
| LUBRIZOL ® 2061 | N/A | no | yes | n/a | n/a | n/a | no |
| (polymeric | | | | | | | |
| phosphate ester) | | | | | | | |
| LUBRIZOL ® 2062H | N/A | no | yes | n/a | n/a | n/a | no |
| (polymeric | | | | | | | |
| phosphate ester) | | | | | | | |
| LUBRIZOL ® 2063 | N/A | no | yes | n/a | n/a | n/a | no |
| (polymeric | | | | | | | |
| phosphate ester) | | | | | | | |
| POLARTECH ® BA | N/A | no | yes | n/a | n/a | n/a | No |
| 30T (Boron- | | | | | | | |
| containing corrosion | | | | | | | |
| inhibitor) | | | | | | | |
| SP CRODAFOS ™ | 39464- | yes | yes | n/a | n/a | yes | no |
| 03A MBAL-LQ- | 69-2 | | | | | | |
| (MH) | | | | | | | |
| (Polyoxyethylene | | | | | | | |
| Oleyl Ether | | | | | | | |
| Phosphate) | | | | | | | |

An exemplary paint remover composition (Example 1) (as shown in Table 2) was prepared and compared to comparative paint remover compositions (Comparative 1 and Comparative 2) (as shown in Tables 3 and 4 respectively).

TABLE 2
Example 1

| | | | Weight |
|---|---|---|---|
| | CAS No. | Function | Percentage |
| Benzyl alcohol | 100-51-6 | Solvent | 40 |
| Water | 7732-18-5 | Solvent | 43.611 |
| Dipentene (terpene | 68956-56-9 | Solvent | 7.5 |
| hydrocarbon) | | | |
| Phosphoric acid (85% | 7664-38-2 | Activator | 5.88 |
| in water) | | | |
| Irgamet 39 N,N-bis- | 94270-86-7 | Corrosion Inhibitor of | 0.625 |
| (2-ethylhexyl)-ar- | | yellow metals | |
| methyl-1H- | | | |
| benzotriazole-1- | | | |
| methanamine | | | |
| COLA ®Fax 3397 | 39464-69-2 | Corrosion inhibitor | 1.0 |
| (Alcohol Ethoxylate | | | |
| Phosphate Ester) | | | |
| Hydroxypropyl | 9004-65-3 | Thickener | 0.65 |
| methylcellulose | | | |
| Benzalkonium | n/a | Thickener/Stabilizer | 0.4 |
| Sepiolite and | | | |
| Benzalkonium | | | |
| Montmorillonite | | | |
| Paraffin wax | 64742-43-4 | Thickener | 0.3 |
| Orange Dye | n/a | Dye | 0.03 |
| Denatonium benzoate | 3734-33-6 | Oral deterrent | 0.004 |

TABLE 3
Comparative 1

| | | | Weight |
|---|---|---|---|
| | CAS No. | Function | Percentage |
| Benzyl alcohol | 100-51-6 | Solvent | 42.5 |
| Polysaccharide | 9005-25-8 | Thickener/ | 27.3 |
| | | Stabilizer | |
| Water | 7732-18-5 | Solvent | 12.5 |
| 2-butoxy-ethanol | 111-76-2 | Solvent | 7.5 |
| 2-(2-aminoethoxy) | 929-06-6 | Activator | 4.7 |
| ethanol | | | |
| Hydrotreated light | 64742-47-8 | Thickener/ | 3.0 |
| distillate (petroleum) | | Stabilizer | |
| Alkyl quaternary | n/a | Thickener/ | 0.5 |
| ammonium bentonite | | Stabilizer | |
| Hydroxypropyl | 9004-65-3 | Thickener/ | 0.5 |
| methylcellulose | | Stabilizer | |
| Ethoxylated alcohol | 68439-46-3 | Surfactant | 0.5 |
| Turpentine, pure gum | 7785-26-4 and | Solvent | 1.0 |
| spirits | 8006-64-2 | | |

TABLE 4
Comparative 2

| | | | Weight |
|---|---|---|---|
| | CAS No. | Function | Percentage |
| Water | 7732-18-5 | Solvent | 44.91 |
| Benzyl alcohol | 100-51-6 | Solvent | 40.0 |
| Turpentine, pure gum | 7785-26-4 and | Solvent | 5.75 |
| spirits | 8006-64-2 | | |
| Formic acid (85-95%) | 64-18-6 | Activator | 4.7 |
| p-mentha-1,4 (8)-diene | 586-62-9 | Solvent | 2.63 |
| Hydroxypropyl cellulose | 9004-64-2 | Thickener | 1.0 |
| Benzalkonium Sepiolite | n/a | Thickener/ | 0.5 |
| and Benzalkonium | | Stabilizer | |
| Montmorillonite | | | |
| Paraffin wax (refined) | 64742-43-4 | Thickener | 0.3 |
| Polyoxyethylene sorbitan | 9005-70-3 | Surfactant | 0.5 |
| Trioleate | | | |
| Sorbitane trioleate | 26266-58-0 | Surfactant | 0.5 |
| Orange dye | n/a | Dye | 0.05 |

### Paint Removal Time

Each paint remover composition, along with the comparative paint remover composition was evaluated on latex-based paints and oil-based paints. Each board was painted with five layers of differently colored paint that has been dried and aged for at least two years. Each composition, Example 1, Comparative 1, and Comparative 2, were applied to the boards. Each composition's ability to remove each layer of paint at 15 minutes, 30 minutes, 1 hour, and greater than 2 hours were charted in Tables 6 and Table 7.

TABLE 6

| | | | | | Number of |
|---|---|---|---|---|---|
| | | | | | Layers |
| Paint Type | Board # | Composition | Time | | Removed |
| Latex based | 1 | Ex. 1 | 15 | min | 0 |
| paints | | | 30 | min | 2 |
| | | | 1 | hr | 5 |
| | | | 2 | hr+ | 5 |
| | | Comp. 2 | 15 | min | 0 |
| | | | 30 | min | 2 |
| | | | 1 | hr | 5 |
| | | | 2 | hr+ | 5 |
| | | Comp. 1 | 15 | min | 0 |
| | | | 30 | min | 1 |
| | | | 1 | hr | 4 |
| | | | 2 | hr+ | 5 |
| | 2 | Ex. 1 | 15 | min | 1 |
| | | | 30 | min | 4 |
| | | | 1 | hr | 5 |
| | | | 2 | hr+ | 5 |
| | | Comp. 2 | 15 | min | 1 |
| | | | 30 | min | 5 |
| | | | 1 | hr | 5 |
| | | | 2 | hr+ | 5 |
| | | Comp. 1 | 15 | min | 1 |
| | | | 30 | min | 2 |
| | | | 1 | hr | 2 |
| | | | 2 | hr+ | 5 |
| | 3 | Ex. 1 | 15 | min | 1 |
| | | | 30 | min | 1 |
| | | | 1 | hr | 3 |
| | | | 2 | hr+ | 5 |
| | | Comp. 2 | 15 | min | 1 |
| | | | 30 | min | 2 |
| | | | 1 | hr | 4 |
| | | | 2 | hr+ | 5 |
| | | Comp. 1 | 15 | min | 1 |
| | | | 30 | min | 1 |
| | | | 1 | hr | 3 |
| | | | 2 | hr+ | 5 |
| | 4 | Ex. 1 | 15 | min | 1 |
| | | | 30 | min | 2 |
| | | | 1 | hr | 4 |
| | | | 2 | hr+ | 5 |
| | | Comp. 2 | 15 | min | 1 |
| | | | 30 | min | 2 |
| | | | 1 | hr | 5 |
| | | | 2 | hr+ | 5 |
| | | Comp. 1 | 15 | min | 0 |
| | | | 30 | min | 1 |
| | | | 1 | hr | 3 |
| | | | 2 | hr+ | 5 |
| | 7 | Ex. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 2 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | 8 | Ex. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 2 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |

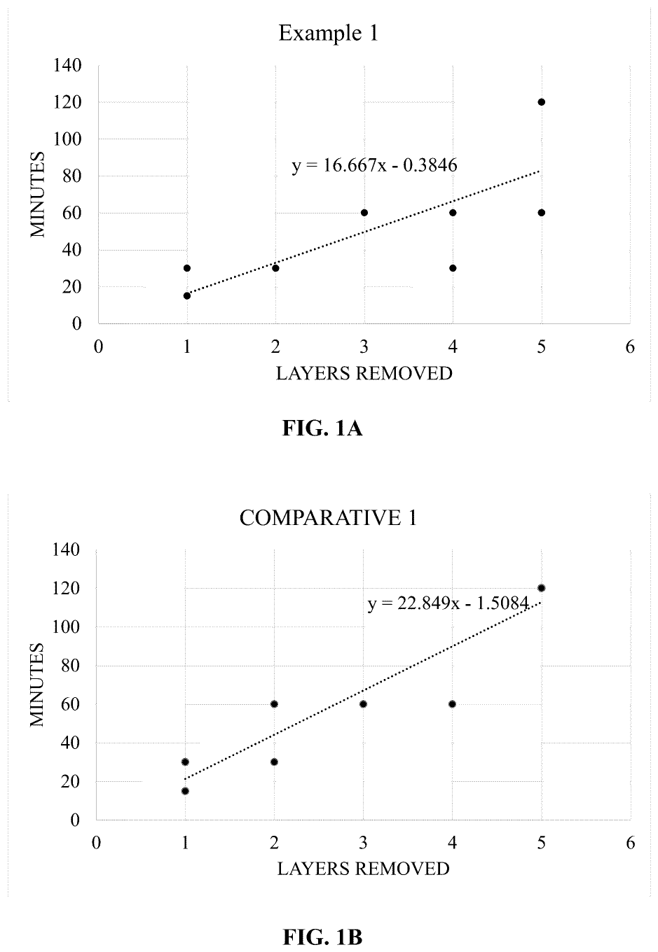

The graphs in FIGS. 1A and 1B visually illustrates the data for the removal of latex paint from Table 6. The slope for each graph was compared to show a 27% increase in the stripping time of latex paint for Example 1 compared to Comparative 1.

TABLE 7

| | | | | | Number of |
|---|---|---|---|---|---|
| | | | | | Layers |
| Paint Type | Board # | Composition | Time | | Removed |
| Oil-Based | 5 | Ex. 1 | 1 | hr | 0 |
| paints | | | 2 | hr | 0 |
| | | | 3 | hr | 0 |
| | | | 4 | hr | 0 |
| | | | 5 | hr | 0 |
| | | | 6 | hr | 0 |
| | | | 8 | hr | 0 |
| | | | 16 | hr | 5 |
| | | Comp. 2 | 1 | hr | 0 |
| | | | 2 | hr | 0 |
| | | | 3 | hr | 0 |
| | | | 4 | hr | 0 |
| | | | 5 | hr | 0 |
| | | | 6 | hr | 0 |
| | | | 8 | hr | 0 |
| | | | 16 | hr | 5 |
| | | Comp. 1 | 1 | hr | 0 |
| | | | 2 | hr | 0 |
| | | | 3 | hr | 0 |
| | | | 4 | hr | 0 |
| | | | 5 | hr | 0 |
| | | | 6 | hr | 0 |
| | | | 8 | hr | 0 |
| | | | 16 | hr | 0 |
| | 6 | Ex. 1 | 1 | hr | 0 |
| | | | 2 | hr | 0 |
| | | | 3 | hr | 0 |
| | | | 4 | hr | 0 |
| | | | 5 | hr | 0 |
| | | | 6 | hr | 0 |
| | | | 8 | hr | 0 |
| | | | 16 | hr | 5 |
| | | Comp. 2 | 1 | hr | 0 |
| | | | 2 | hr | 0 |
| | | | 3 | hr | 0 |
| | | | 4 | hr | 5 |
| | | | 5 | hr | 0 |
| | | | 6 | hr | 0 |
| | | | 8 | hr | 5 |
| | | | 16 | hr | 5 |
| | | Comp. 1 | 1 | hr | 0 |
| | | | 2 | hr | 0 |
| | | | 3 | hr | 0 |
| | | | 4 | hr | 0 |
| | | | 5 | hr | 0 |
| | | | 6 | hr | 0 |
| | | | 8 | hr | 5 |
| | | | 16 | hr | 5 |
| | 7 | Ex. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 2 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | 8 | Ex. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 2 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |
| | | Comp. 1 | 1 | hr | 5 |
| | | | 2 | hr | 5 |
| | | | 3 | hr | 5 |
| | | | 4 | hr | 5 |
| | | | 5 | hr | 5 |
| | | | 6 | hr | 5 |
| | | | 8 | hr | 5 |
| | | | 16 | hr | 5 |

### Corrosion Inhibition

Using the United Nations Manual of Tests and Criteria, Section 37, this paint remover formula (Ex. 1) was tested to determine its effect on corrosion on aluminum and steel. The results are shown in Table 8. the composition shows increased corrosion on aluminum and steel substrates.

TABLE 8

% Mass Loss

| | Aluminum | Steel |
|---|---|---|
| Submerged | 2.51% | 1.06% |
| Half/Half | 1.07% | 0.50% |
| Head Space | −0.01% | 0.20% |

### Wood Darkening

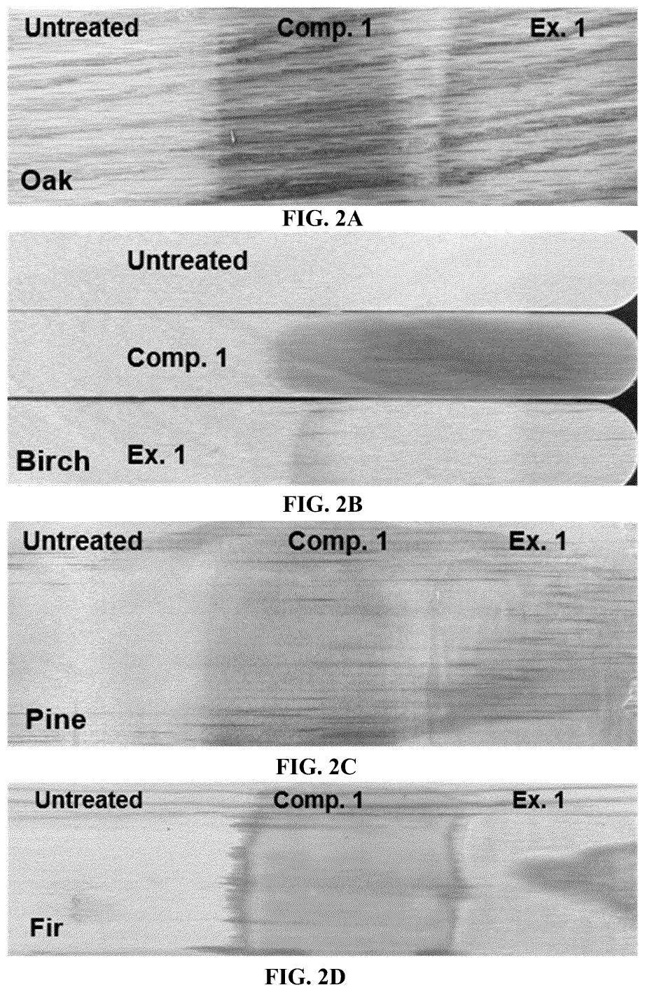

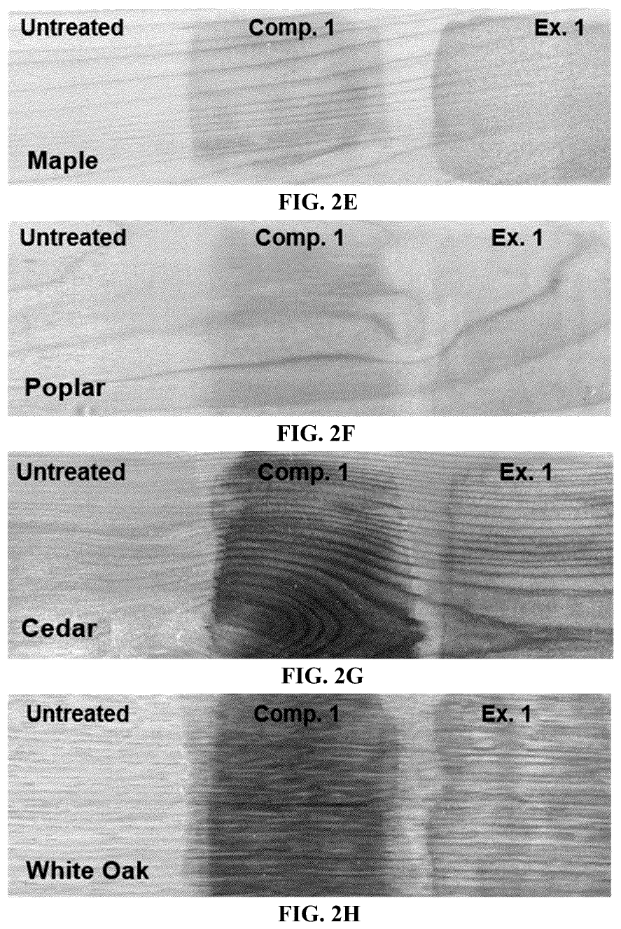

Table 9 represents the darkening of wood by use of a colorimeter (Precise Color Reader model WR-10QC made by ShenZhen Wave Optoelectronics Technology). The L value was taken for various wood types before and after application of different paint removers (Example 1 and Comparative 1). Negative L values indicate the darkening of wood. Comparative 1 exhibited negative L values for each type of wood, thus demonstrating that Comparative 1 caused significant wood darkening. Example 1 exhibited negative L values for only two types of wood (i.e., Fir and Maple). Overall, Example 1 demonstrated less wood darkening of each type of wood and a significant improvement in L values compared to Comp. 1. FIGS. 2A-2H show the difference in wood darkening between Example 1 and Comparative 1 compared to an untreated sample for various wood types. Comparative 1 caused each wood type to darken significantly, while Example 1 caused minor wood darkening when compared to Comparative 1.

TABLE 9

| | | | L for | L for | | Change in L |
|---|---|---|---|---|---|---|
| | | L for top | middle | bottom | | value |
| Wood | | portion of | portion of | portion of | L | compared to |
| Type | Composition | test area | test area | test area | average | ‘Untreated’ |
| Oak | Untreated | 67.71 | 68.52 | 65.95 | 67.39 | |
| | Comp. 1 | 66.07 | 66.42 | 68.04 | 66.84 | −0.55 |
| | Ex. 1 | 70.65 | 68.88 | 70.42 | 69.98 | 2.59 |
| Birch | Untreated | 80.15 | 79.42 | 78.28 | 79.28 | |
| | Comp. 1 | 70.17 | 70.64 | 71.59 | 70.80 | −8.48 |
| | Ex. 1 | 80.21 | 80.73 | 80.39 | 80.44 | 1.16 |
| Pine | Untreated | 79.49 | 80.88 | 77.19 | 79.19 | |
| | Comp. 1 | 70.78 | 72.6 | 72.93 | 72.10 | −7.08 |
| | Ex. 1 | 81.90 | 78.73 | 80.53 | 80.39 | 1.20 |
| Fir | Untreated | 82.08 | 81.30 | 80.66 | 81.35 | |
| | Comp. 1 | 74.79 | 74.91 | 74.88 | 74.86 | −6.49 |
| | Ex. 1 | 80.90 | 81.51 | 79.35 | 80.59 | −0.76 |
| Maple | Untreated | 81.68 | 81.91 | 81.34 | 81.64 | |
| | Comp. 1 | 76.98 | 75.71 | 77.00 | 76.56 | −5.08 |
| | Ex. 1 | 80.42 | 80.05 | 79.72 | 80.06 | −1.58 |
| Poplar | Untreated | 78.65 | 78.68 | 79.9 | 79.08 | |
| | Comp. 1 | 75.96 | 77.32 | 77.41 | 76.90 | −2.18 |
| | Ex. 1 | 82.03 | 79.74 | 80.67 | 80.81 | 1.74 |
| Cedar | Untreated | 54.86 | 52.96 | 60.98 | 56.27 | |
| | Comp. 1 | 51.79 | 51.4 | 57.82 | 53.67 | −2.60 |
| | Ex. 1 | 59.94 | 57.63 | 61.22 | 59.60 | 3.33 |

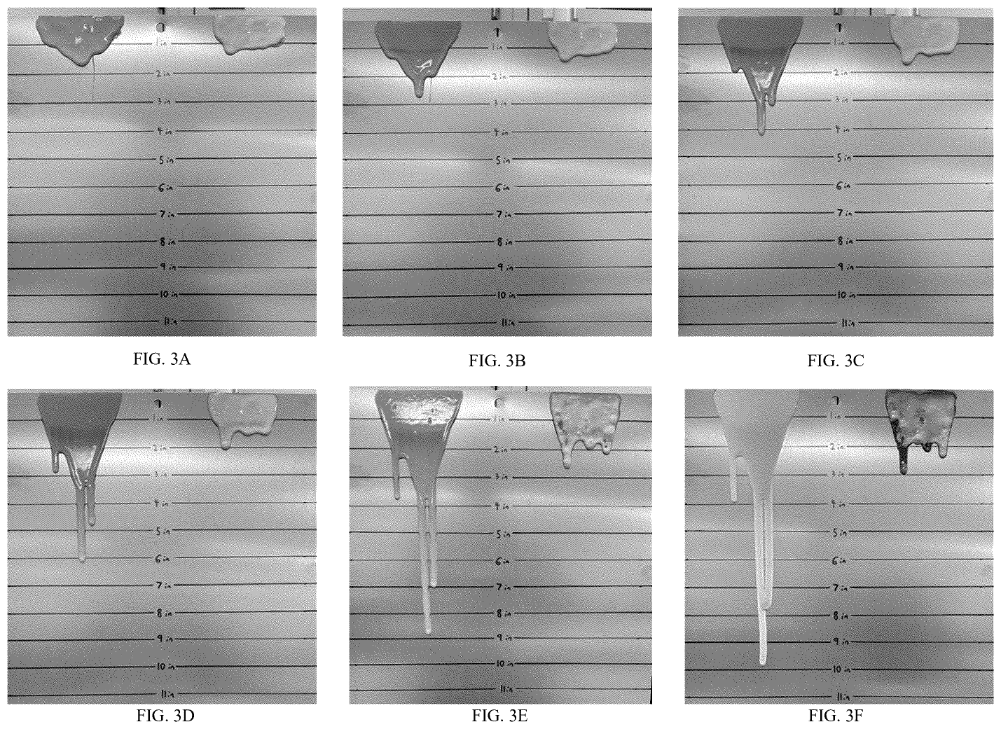

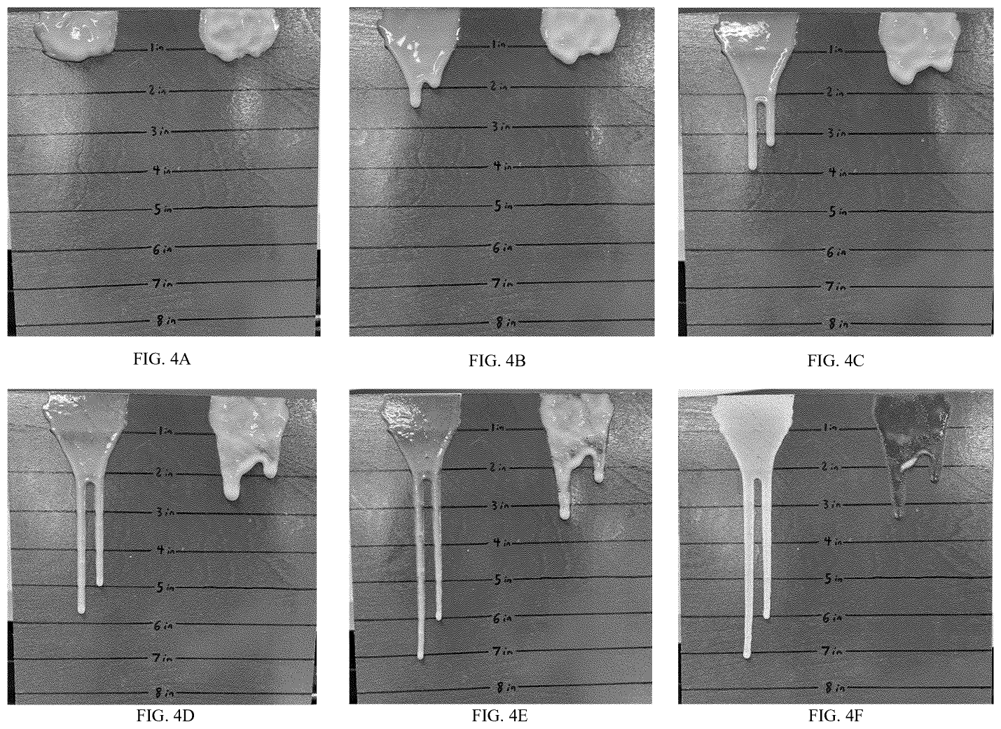

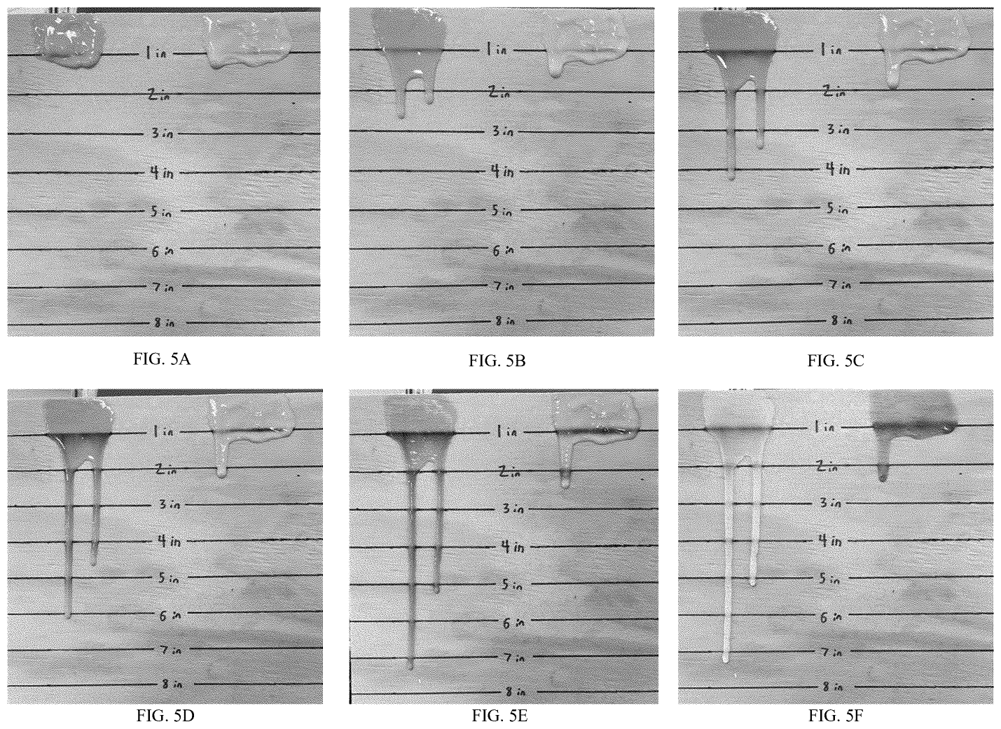

FIGS. 3A-3F, 4A-4F, and 5A-5F show the difference in efficacy between Comparative 1 (shown on left) and Example 1 (shown on right) on an aluminum substrate at 90 degrees. FIG. 3A shows the results directly after application of each composition to the aluminum substrate. FIG. 3B (5 minutes), FIG. 3C (15 minutes), FIG. 3D (1 hour), FIG. 3E (7 hours), and FIG. 3F (72 hours) after application of each composition to the aluminum substrate. The dwell time, or vertical cling, of the composition increases the amount of time the composition stays on a surface and removes paint. Although the two compositions did not have a significant observable different in viscosity, Example 1 had significantly increased dwell time as indicated by FIGS. 3A-3F which show at 72 hours on an aluminum substrate, the composition only traveled three inches, compared to Comparative 1 which traveled to nearly ten inches in 72 hours. The increased distance traveled causes the composition to prematurely dry and prevents the composition from further removing paint. Since Example 1 does not travel as far and thus, is still wet and capable of removing paint. FIGS. 4A-4F show the same study with Comparative 1 (shown on left) and Example 1 (shown on right) on a painted wood substrate. Similar results were achieved with Comparative 1 reaching over 7 inches, whereas Example 1 reached around 3 inches. FIGS. 5A-5F show the same study with Comparative 1 (shown on left) and Example 1 (shown on right) on an untreated wood substrate. Similar results were achieved with Comparative 1 reaching over 7 inches, whereas Example 1 reached around 2.5 inches.

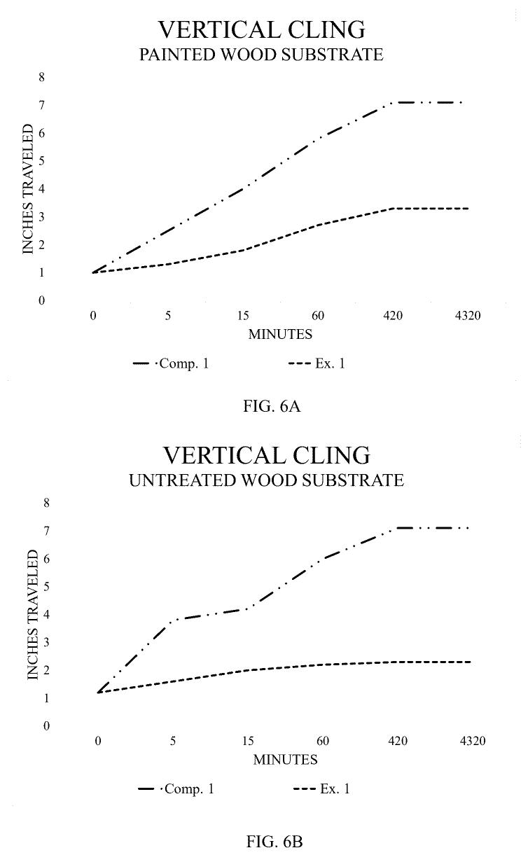

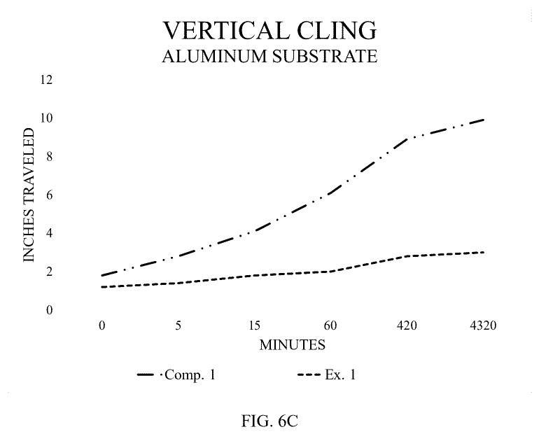

The data from the studies shown in FIGS. 3A-3F, 4A-4F, and 5A-5F are illustrated graphically in FIGS. 6A-6C. The vertical cling data for a painted wood substrate, FIG. 6A, clearly show that Example 1 has a greater vertical cling, or dwell time, than comparative 1. The vertical cling data for an untreated wood substrate, FIG. 6B, clearly show that Example 1 has a greater vertical cling, or dwell time, than comparative 1. The vertical cling data for an aluminum substrate, FIG. 6C, clearly show that Example 1 has a greater vertical cling, or dwell time, than comparative 1.

### Overall Efficacy

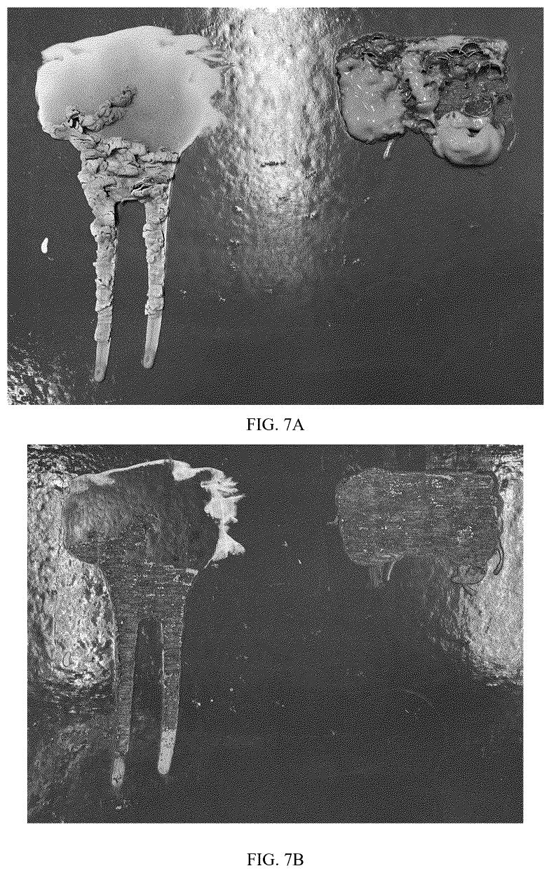

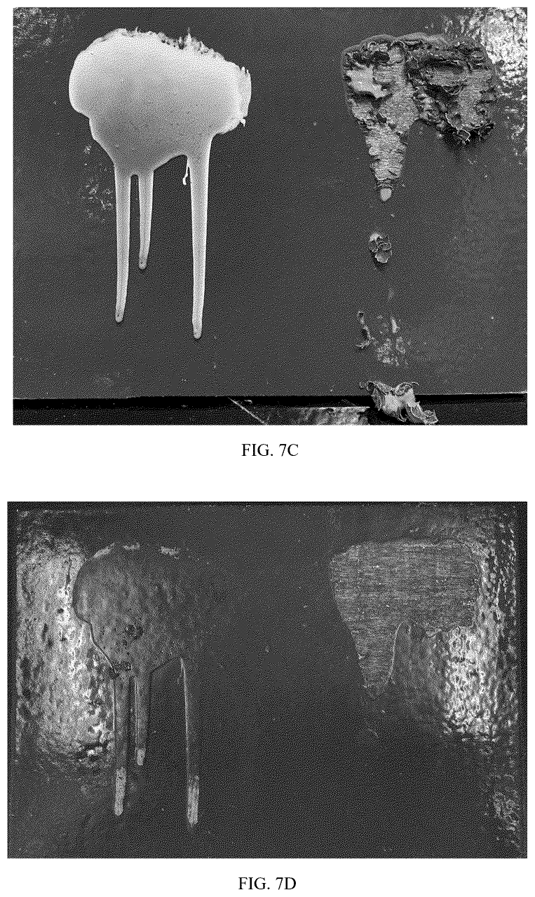

FIGS. 7A and 7B show the difference in efficacy, on substrates painted with oil-based paint, between Comparative 1 (shown on left) and Example 1 (shown on right) on a painted wood substrate at a 70° angle. Both compositions were applied and remained on the substrate overnight (16-18 hours). FIG. 7A displays the paint removal efficacy before being scraped, whereas FIG. 7B displays the paint removal efficacy after being scraped. FIGS. 7C and 7D show the difference in efficacy between Comparative 1 (shown on left) and Example 1 (shown on right) on a painted wood substrate at a 90° angle. Both compositions were applied and remained on the substrate overnight. FIG. 7C displays the paint removal efficacy before being scraped, whereas FIG. 7D displays the paint removal efficacy after being scraped. When viewing FIGS. 7A-7D, Example 1 (shown on right) exhibits increased paint removal efficacy/performance compared to Comparative 1 (shown on the left) at both a 70° angle and a 90° angle. The increased dwell time or vertical cling of Example 1 allows the composition to penetrate the paint layer and remove each layer of paint.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A paint remover composition comprising:
a. from 15 weight percent to 70 weight percent of a primary solvent, based on the total weight of the composition, wherein the primary solvent is benzyl alcohol;
b. from 10 weight percent to 70 weight percent water, based on the total weight of the composition;
c. a secondary solvent; and
d. an alcohol ethoxylate phosphate ester at an effective concentration to emulsify the composition and provide corrosion inhibition;
wherein, the composition is an emulsion.

2. The paint remover composition according to claim 1, further comprising an acidic activator.

3. The paint remover composition according to claim 2, wherein the acidic activator comprises phosphoric acid, formic acid, glycolic acid, or a combination thereof.

4. The paint remover composition according to claim 1, wherein the secondary solvent comprises dipentene, toluene, turpentine, mineral spirits, xylene, DMSO, and combinations thereof.

5. The paint remover composition according to claim 1, further comprising a thickener.

6. The paint remover composition according to claim 1, further comprising a propellant.

7. The paint remover composition according to claim 1, further comprising a secondary corrosion inhibitor.

8. The paint remover composition according to claim 1, wherein the benzyl alcohol and water are present in the composition at a ratio of 1.5:1 to 1:1.5 relative to one another.

9. The paint remover composition according to claim 1, wherein the benzyl alcohol and water are present in the composition at a ratio of 1:1 ratio relative to one another.

10. The paint remover composition according to claim 1, wherein the alcohol ethoxylate phosphate ester has a hydrophilic lipophilic balance from 3 to 7.

11. The paint remover composition according to claim 1, wherein the alcohol ethoxylate phosphate ester comprises a monophosphate ester, a diphosphate ester, or a combination thereof.

12. The paint remover composition according to claim 1, wherein the alcohol ethoxylate phosphate ester has 2-10 degrees of ethoxylation.

13. The paint remover composition according to claim 1, wherein the alcohol ethoxylate phosphate ester has 3-5 degrees of ethoxylation.

14. The paint remover composition according to claim 1, wherein the alcohol ethoxylate phosphate ester comprises an alcohol chain that is from 16 to 22 carbons long.

15. The paint remover composition according to claim 14, wherein the alcohol chain is oleyl alcohol.

16. The paint remover composition according to claim 1, wherein the composition removes at least three layers of latex-based paint after one hour.

17. The paint remover composition according to claim 1, wherein the composition removes at least five layers of oil-based paint after twenty-four hours.

18. The paint remover composition according to claim 1, wherein when the composition is applied to wood it results in treated wood having an L-value of greater than −2, when compared to untreated wood.

19. The paint remover composition according to claim 1, wherein the composition has a flash point of 70° F. or greater.

20. The paint remover composition according to claim 1, wherein the composition as a volatile organic compound (VOC) content of 50 weight percent or less, based on the total weigh of the composition.

21. A method of removing paint from a substrate, the method comprising:
a. applying the composition according to claim 1 to a painted substrate;
b. leaving the composition on the painted substrate for a period of time; and
c. removing paint from the substrate.

22. The method according to claim 21, wherein the substrate is metal or wood.

23. The method according to claim 21, wherein the method removes at least three layers of latex-based paint after one hour.

24. The method according to claim 21, wherein the method removes at least five layers of oil-based paint after twenty-four hours.
